(19) United States
(12) Patent Application Publication
(10) Pub. No.: US 2023/0075961 A1
(43) Pub. Date: Mar. 9, 2023

(54) ENERGY STORAGE ASSEMBLY FOR A MOTOR VEHICLE

(71) Applicant: AUDI AG, Ingolstadt (DE)

(72) Inventors: Oliver STOLL, Waldbrunn (DE); Florian MOLDERING, Neckarsulm (DE); Bernd MLEKUSCH, Sankt Veit/Glan (AT); Jannik MEYER, Bohmte (DE)

(73) Assignee: AUDI AG, Ingolstadt (DE)

(21) Appl. No.: 17/798,161

(22) PCT Filed: Sep. 22, 2020
(86) PCT No.: PCT/EP2020/076416

§ 371 Date: Aug. 8, 2022

(51) Int. Cl. F17C 13/12; B60K 1/04; B60K 15/03

(52) U.S. Cl. CPC F17C 13/123; B60K 1/04; B60K 15/03; F17C 2223/0161; B60K 2015/03375; B60Y 2306/01; B60Y 2400/306; F17C 2201/056; F17C 2201/058; F17C 2203/0617; F17C 2205/0115; F17C 2205/0119; F17C 2221/012; F17C 2221/033; F17C 2223/0123; F17C 2223/036; F17C 2250/0434; F17C 2250/0626; F17C 2260/04; F17C 2260/042; F17C 2265/04; F17C 2270/0178

(57) ABSTRACT

An energy storage assembly for a motor vehicle, including a traction battery for storing electrical energy. A flexible pressure element, which is filled with gas or liquid is disposed on the outside of the traction battery or on the inside of a covering component for the traction battery, the gas or the liquid is contained at atmospheric pressure within the flexible pressure element. A pressure sensor is connected to the flexible pressure element, and by which collision-induced pressure fluctuations in the flexible pressure element can be sensed.

### FIELD

The invention relates to an energy storage assembly for a motor vehicle having at least one energy storage device for storing fuel or electrical energy.

An energy storage device within the meaning of the present invention is preferably a fuel tank, in particular a pressure tank, or a traction battery, as explained in more detail below.

### BACKGROUND

When a motor vehicle collides, in particular in a traffic accident with another motor vehicle or an obstacle (this also includes the vehicle touching down on a ground obstacle), the energy storage device can be damaged or pre-damaged as a result of an external force. Such damage or pre-damage is often not noticed or remains undetected and can then lead to considerable consequential damage.

DE 10 2015 225 348 A1 describes a pressure container for storing fuel in a motor vehicle. The pressure container (10) has a layered structure (11). A detection substance (15) is embedded in the layered structure (11). The detection substance (15) is preferably an odorous substance. The detection substance (15) and the layered structure (11) are designed in such a way that more detection substance (15) escapes from the layered structure (11) if the layered structure (11) is damaged. As a result, damage to the pressure container (10) can be sensed comparatively easily.

### SUMMARY

The energy storage assembly according to the invention enables collisions to be reliably sensed with a comparatively simple and cost-effective design, so that at least one protective measure can subsequently be initiated. On the one hand, this improves or increases safety and, on the other hand, reduces possible follow-up costs (such as inspection costs or repair costs). Additional features of the invention result from the dependent claims, the following description of the invention and the figures.

The energy storage assembly according to the invention comprises at least the following components, which can each also be present in multiples:
(at least) one energy storage device for storing fuel or for storing electrical energy;
(at least) one gas or liquid-filled flexible pressure element, which is arranged on the outside of the energy storage device or which is arranged on the inside of a covering component for the energy storage device;
(at least) one pressure sensor connected to the flexible pressure element, with which collision-induced pressure fluctuations in the flexible pressure element are detectable or can be sensed.

With the energy storage assembly according to the invention, a collision which in particular only occurs locally in the region of the energy storage device and which possibly leads to damage to the energy storage device can be captured or sensed. The energy storage assembly according to the invention thus has a collision recognition or collision detection. If a collision is sensed, at least one protective measure can then be taken to avert danger or to protect the energy storage device and the motor vehicle and people and/or the environment.

An energy storage device is preferably a traction battery or a traction battery for storing electrical energy for an electric traction drive or a fuel tank for storing fuel (for example petrol, diesel or gas) for operating an internal combustion engine. An energy storage device is in particular a pressure tank (or a pressure tank assembly with a plurality of pressure tanks) for storing fuel, preferably for storing hydrogen (H₂) for a hydrogen drive or for storing natural gas (CNG) for a natural gas drive, with internal pressures in such a pressure tank of up to 700 bar and more.

The energy storage assembly according to the invention is therefore preferably a component of a motor vehicle, in particular a passenger car or a light commercial vehicle, with a hydrogen drive, natural gas drive or electric drive (traction drive) or is used for such a motor vehicle. The invention thus also relates, at least indirectly, to a motor vehicle with such a drive or a corresponding hybrid drive and with at least one energy storage assembly according to the invention.

The flexible pressure element has an at least partially flexible, in particular flexibly elastic, sheath that is filled with a gas (this also includes a gas mixture, such as air in particular) or with a liquid, with the sheath forming a quasi-hermetically sealed volume-limiting element for the gas or the liquid. The flexible pressure element can also be referred to as a gas-filled or liquid-filled flexible pressure element. The gas or liquid is preferably non-flammable and/or environmentally hazardous. By “flexible” is meant that the sheath is not rigid but compliant. The flexible sheath is preferably formed from a thermoplastic material, for example from polypropylene (PP) or polyethylene (PE), from an elastomer, from a silicone or the like and can also have a barrier layer and/or have a fabric reinforcement. The sheath preferably has a wall thickness of 0.1 mm to 1.0 mm. An external force acting on the flexible or yielding sheath, in particular as a result of a collision, causes pressure fluctuations or pressure waves inside the pressure element, i.e. in the gas or in the liquid, which can be sensed using at least one pressure sensor.

The at least one pressure sensor of the energy storage assembly according to the invention is designed in particular to detect or measure the pressure (internal pressure) inside the flexible pressure element (i.e. the gas pressure or the liquid pressure) and to generate corresponding measured values, in particular in the form of electrical signals.

The flexible pressure element can be arranged on the outside of the energy storage device, preferably in such a way that the energy storage device is covered at least locally, in particular in at least one region at risk of damage, and in particular in such a way that the energy storage device is essentially completely covered or surrounded by the flexible pressure element. Depending on the situation, this enables local or comprehensive monitoring of the energy storage device. The flexible pressure element is suitably fastened to the energy storage device. It goes without saying that a plurality of flexible pressure elements can also be provided, which partially or completely cover the energy storage device. In the event of a collision, pressure fluctuations or pressure waves are generated in the flexible pressure element, as described above.

The flexible pressure element can also be arranged on the inside of a covering component or the like for the energy storage device, which at least partially surrounds the energy storage device. The inside is a side or surface of the covering component that faces the energy storage device. The flexible pressure element is fastened to the covering component in a suitable manner, it also being possible for a plurality of flexible pressure elements to be arranged on a covering component and fastened in a suitable manner. The covering component is preferably a (flat) sheet metal component or a flat plastic component, in particular with fiber reinforcement. The covering component not only serves as a support for the flexible pressure element, but also offers mechanical protection for the energy storage device (protection plate effect). The covering component is preferably part of a rear paneling or underbody paneling of the motor vehicle. The covering component can rest against the energy storage device, so that the flexible pressure element is located directly between the energy storage device and the covering component. The covering component can also be arranged at a distance from the energy storage device, the distance preferably being 5 mm to 50 mm and in particular 10 mm to 30 mm. In the event of a collision, the covering component is pressed against the energy storage device, as a result of which pressure fluctuations or pressure waves are generated in the flexible pressure element, as described above.

In both of the above-described possible embodiments of the invention, the at least one flexible pressure element is arranged almost in the immediate vicinity of the energy storage device.

The flexible pressure element is preferably designed as a (flexible) pressure pad. The sheath of such a pressure pad preferably consists of two flexible, in particular flexible elastic surface parts which are connected to one another at their edges. In particular, a thermoplastic film material can be used for the production of the pressure pad, which is overlapped twice and welded at the edges. The pressure pad is filled with gas or liquid. The pressure pad preferably has a maximum thickness of 10 mm, so that only a small installation space is required.

The pressure pad can be segmented and have a plurality of chambers filled with gas or liquid, with a pressure sensor being provided specifically for each chamber. This enables the localization of a force effect and reduces the inspection effort. Furthermore, at least one internal pressure compensation valve effective between adjacent chambers can be provided, which allows for a gradual (i.e. only gradual or slow) pressure compensation and/or enables a gradual gas exchange or liquid exchange between the chambers.

The gas, in particular air, or the liquid is preferably enclosed at atmospheric pressure (ambient pressure) inside the flexible pressure element, so that no pressure loss or negative pressure loss can occur. The flexible pressure element can have at least one external pressure equalization valve for successive pressure equalization and/or possibly also provide air exchange with the environment. In the case of a plurality of chambers, at least one outer pressure equalization valve is preferably provided per chamber or only one single outer pressure equalization valve and at least one inner pressure equalization valve are provided.

The pressure sensor can be arranged directly on the flexible pressure element (and connected in a suitable manner). The pressure sensor can then be fastened to the covering component, for example. The pressure sensor is preferably arranged at a distance from the flexible pressure element and is connected via a line to the flexible pressure element (or optionally to a chamber of the pressure pad) or to the flexible pressure element (or the relevant chamber). In particular, it is provided that the line is connected at one of its ends to the flexible pressure element, which is preferably designed with a line connection for this purpose, and that the pressure sensor is connected to the other end of the line. In particular, a detachable connection is provided in each case. In order to prevent incorrect measurements caused by the line, it can be designed as a pressure-resistant line, in particular as a steel braided line or the like.

The pressure tank assembly according to the invention can also include:
a control device or a control apparatus which is designed to automatically evaluate the (continuously recorded) measured values of the pressure sensor and in the event of a collision (which leads to impermissible pressure fluctuations caused by the collision) to cause or initiate at least one protective measure.

Possible protective measures are, for example, issuing a warning message to the driver (e.g. “Urgently visit the local service center!”), switching off the vehicle drive, preventing a refueling process or a charging process and the like.

The control device can also be designed to also determine or assess the collision severity from the measured values of the pressure sensor and to cause or initiate at least one appropriate protective measure depending on the collision severity determined.

The control device can also be designed to localize the region or regions of a collision-related force acting on the energy storage device from the measured values of a plurality of pressure sensors, which in particular are each assigned to a chamber of a pressure pad. This can then be visualized, for example, by means of a display in the vehicle cockpit or on a diagnostic device.

### BRIEF DESCRIPTION OF THE FIGURES

In the following, the invention will be explained in greater detail with reference to figures. The features shown in the figures and/or the features explained below can be general features of the invention, even independently of specific combinations of features, and develop the invention accordingly.

FIG. 1 shows a schematic sectional view (not to scale) of a first preferred embodiment of an energy storage assembly according to the invention for a motor vehicle, with a pressure tank as the energy storage device.

FIG. 2 shows a schematic sectional view (not to scale) of a second preferred embodiment of an energy storage assembly according to the invention for a motor vehicle, with a pressure tank as the energy storage device.

### DETAILED DESCRIPTION

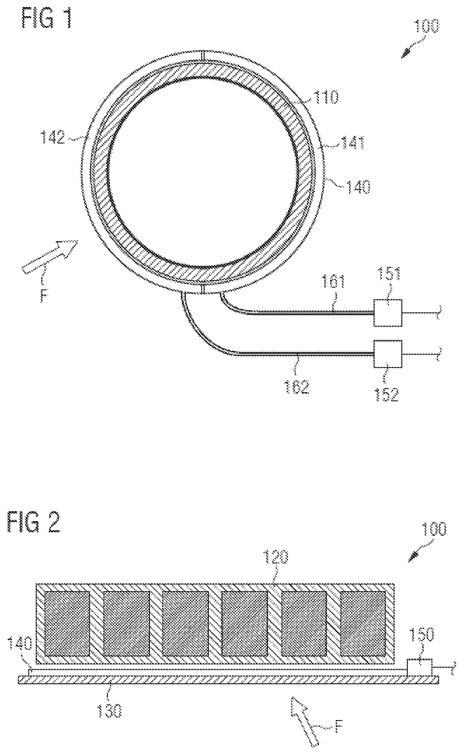

The energy storage assembly 100 shown in FIG. 1 comprises a pressure tank 110 with a rigid tank wall and a flexible pressure element 140 designed as a pressure pad. The pressure tank 110 can be formed in a known manner with a liner (inner sheath) and a fiber sheathing (outer sheath). The flexible pressure element 140 is arranged on the outside of the pressure tank 110, so that the pressure tank 110 is completely covered, at least in portions, in the cylindrical region that is particularly at risk of damage. The flexible pressure element 140 enclosing the pressure tank 110 has two chambers 141, 142, which are each filled with gas, in particular air, or liquid, it also being possible for more than two chambers to be provided. The flexible pressure element or pressure pad 140 can be detachably fastened to the pressure tank 110 with clamps, tensioning straps or the like.

When a force F acts as a result of a collision, which is typically an impact load, pressure fluctuations are generated in at least one of the chambers 141, 142 (as explained above). These pressure fluctuations can be sensed or measured using the pressure sensors 151, 152 connected via lines 161, 162, whereupon at least one protective measure can be initiated. The pressure sensors 151, 152 are arranged at appropriate points in the vicinity of the pressure tank 110 and connected to a control device, not shown. (The pressure sensors 151, 152 can be connected to the control device via a vehicle-side bus system, for example a CAN bus.) The flexible pressure element 140, designed as a pressure pad, enables comprehensive and complete detection of the effects of force F on the pressure tank 110. The chambers 141, 142 and the pressure sensors 151, 152 assigned to these chambers 141, 142 also enable at least an approximate localization of the force F.

The energy storage assembly 100 shown in FIG. 2 comprises a traction battery 120 with a rigid housing and battery cells arranged therein, and a covering component 130, it also being possible for a plurality of covering components to be provided. The covering component 130 is, for example, an underride protection. On the inside of the covering component 130, which faces the traction battery 120, there is a flexible pressure element 140 designed as a pressure pad, which is filled with gas, in particular air, or liquid. (The pressure pad 140 may also have multiple chambers.) The pressure pad 140 may be bonded to the inside of the cover member 130.

A pressure sensor 150 is arranged directly on the pressure pad 140 and is fastened to the covering component 130. (The pressure sensor 150 can also be arranged at a distance from the pressure pad 140 and connected to the pressure pad 140 by means of a line.) The pressure fluctuations occurring when a critical force F acts on the covering component 130 in the flexible pressure element or pressure pad 140 can be sensed or measured using the pressure sensor 150, whereupon at least one protective measure can be initiated.

1-10. (canceled)

11. An energy storage assembly for a motor vehicle, comprising:
a traction battery for storing fuel or electrical energy;
a flexible pressure element which is filled with gas or liquid and which is arranged on the outside of traction battery or on the inside of a covering component for the traction battery; wherein the gas or the liquid is contained at atmospheric pressure within the flexible pressure element; and
a pressure sensor which is connected to the flexible pressure element, and by which collision-induced pressure fluctuations in the flexible pressure element can be sensed.

12. The energy storage assembly of claim 11, wherein the flexible pressure element is designed as a pressure pad.

13. The energy storage assembly of claim 12, wherein the pressure pad has a maximum thickness of 10 mm.

14. The energy storage assembly of claim 12, wherein the pressure pad is segmented and has several chambers filled with gas or liquid, a pressure sensor being provided for each chamber.

15. The energy storage assembly of claim 11, wherein the flexible pressure element has at least one pressure compensation valve for pressure compensation with the environment.

16. The energy storage assembly of claim 11, wherein the pressure sensor is arranged directly on the flexible pressure element.

17. The energy storage assembly of claim 11, wherein the pressure sensor is arranged at a distance from the flexible pressure element and is connected to the flexible pressure element via a line.

18. The energy storage assembly of claim 11, further comprising: a control device which is designed to automatically evaluate the measured values of the pressure sensor and to initiate at least one protective measure in the event of a collision.

19. The energy storage assembly of claim 11, wherein the energy storage assembly is part of a motor vehicle with an electric drive.

20. The energy storage assembly of claim 12, wherein the pressure pad is segmented and has several chambers filled with gas or liquid, a pressure sensor being provided for each chamber.

21. The energy storage assembly of claim 12, wherein the flexible pressure element has at least one pressure compensation valve for pressure compensation with the environment.

22. The energy storage assembly of claim 13, wherein the flexible pressure element has at least one pressure compensation valve for pressure compensation with the environment.

23. The energy storage assembly of claim 14, wherein the flexible pressure element has at least one pressure compensation valve for pressure compensation with the environment.

24. The energy storage assembly of claim 12, wherein the pressure sensor is arranged directly on the flexible pressure element.

25. The energy storage assembly of claim 13, wherein the pressure sensor is arranged directly on the flexible pressure element.

26. The energy storage assembly of claim 14, wherein the pressure sensor is arranged directly on the flexible pressure element.

27. The energy storage assembly of claim 15, wherein the pressure sensor is arranged directly on the flexible pressure element.

28. The energy storage assembly of claim 12, wherein the pressure sensor is arranged at a distance from the flexible pressure element and is connected to the flexible pressure element via a line.

29. The energy storage assembly of claim 13, wherein the pressure sensor is arranged at a distance from the flexible pressure element and is connected to the flexible pressure element via a line.

30. The energy storage assembly of claim 14, wherein the pressure sensor is arranged at a distance from the flexible pressure element and is connected to the flexible pressure element via a line.
